(19) United States
(12) Patent Application Publication
(10) Pub. No.: US 2009/0254215 A1
(43) Pub. Date: Oct. 8, 2009

(54) Programmed dispensing of consumable compositions

(75) Inventors: Roderick A. Hyde, Redmond, WA (US); Eric C. Leuthardt, St. Louis, MO (US); Robert W. Lord, Seattle, WA (US); Clarence T. Tegreene, Bellevue, WA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignee: Searete LLC

(21) Appl. No.: 12/383,458

(22) Filed: Mar. 23, 2009

Related U.S. Application Data
(63) Continuation-in-part of application No. 11/998,461, filed on Nov. 29, 2007.
Application No. 11/998,461 is a continuation-in-part of application No. 12/001,061, filed on Dec. 7, 2007.
Application No. 12/001,061 is a continuation-in-part of application No. 12/001,063, filed on Dec. 7, 2007.
Application No. 12/001,063 is a continuation-in-part of application No. 12/002,794, filed on Dec. 18, 2007.
Application No. 12/002,794 is a continuation-in-part of application No. 12/004,094, filed on Dec. 19, 2007.
Application No. 12/004,094 is a continuation-in-part of application No. 12/006,252, filed on Dec. 31, 2007.
Application No. 12/006,252 is a continuation-in-part of application No. 12/012,500, filed on Feb. 1, 2008.
Application No. 12/012,500 is a continuation-in-part of application No. 12/074,245, filed on Feb. 29, 2008.
Application No. 12/074,245 is a continuation-in-part of application No. 12/217,121, filed on Jun. 30, 2008.

(51) Int. Cl. G06F 17/00

(52) U.S. Cl. 700/236

(57) ABSTRACT

Methods and systems for programmed dispensation of consumable compositions are provided.

A system for administering a consumable composition may comprise: (a) means for detecting an administration of a first dose of a consumable composition according to a programmed dosing schedule; and (b) means for dispensing a second dose of a consumable composition according to a time interval since the administration of a first dose of the first consumable composition.

A system for administering a consumable composition may comprise: (a) means for detecting an identity of a first dose of a consumable composition dispensed according to a programmed dosing schedule; and (b) means for dispensing a second dose of a consumable composition according to the identity of the first dose of a consumable composition.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/998,461, entitled Programmed Dispensing of Consumable Compositions, naming Eric C. Leuthardt, Clarence T. Tegreene, Lowell L. Wood, Jr., Roderick A. Hyde and Robert W. Lord as inventors, filed Nov. 29, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/001,061, entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Dec. 7, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/001,063, entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Dec. 7, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/002,794, entitled Communications Regarding Aspects of a Consumable Composition, naming Roderick A. Hyde, Eric C. Leuthardt, Robert W. Lord, Clarence T. Tegreene, and Lowell L. Wood, Jr. as inventors, filed Dec. 18, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/004,094, entitled Communications Regarding Aspects of a Consumable Composition, naming Roderick A. Hyde, Eric C. Leuthardt, Robert W. Lord, Clarence T. Tegreene, and Lowell L. Wood, Jr. as inventors, filed Dec. 19, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/006,252, entitled Sterilization of Consumable Composition Dispensers, naming Roderick A. Hyde, Eric C. Leuthardt, Robert W. Lord, Clarence T. Tegreene, and Lowell L. Wood, Jr. as inventors, filed Dec. 31, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/012,500 entitled Sterilization of Consumable Composition Dispensers, naming Roderick A. Hyde, Eric C. Leuthardt, Robert W. Lord, Clarence T. Tegreene, and Lowell L. Wood, Jr. as inventors, filed Feb. 1, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/074,245 entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Feb. 29, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,121 entitled Reordering of Consumable Compositions, naming Roderick A. Hyde, Eric C. Leuthardt, Robert W. Lord, Clarence T. Tegreene, and Lowell L. Wood, Jr. as inventors, filed Jun. 30, 2008, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND

Programmed regimens of consumable compositions may be prescribed by a physician or may simply be desirable for the health and well-being of an individual. However, confusion may arise concerning the schedule, dosage, and/or compliance with a programmed dosing regimen.

### BRIEF DESCRIPTION OF THE FIGURES

FIG. 1 shows a high-level block diagram of a beverage container.

FIG. 2 is a high-level logic flowchart of a process.

FIG. 3 is a high-level logic flowchart depicting alternate implementations of FIG. 2.

FIG. 4 is a high-level logic flowchart depicting alternate implementations of FIG. 2.

FIG. 5 is a high-level logic flowchart depicting alternate implementations of FIG. 2.

FIG. 6 is a high-level logic flowchart depicting alternate implementations of FIG. 2.

FIG. 7 is a high-level logic flowchart depicting alternate implementations of FIG. 2.

FIG. 8 is a high-level logic flowchart depicting alternate implementations of FIG. 2.

FIG. 9 is a high-level logic flowchart depicting alternate implementations of FIG. 2.

FIG. 10 is a high-level logic flowchart depicting alternate implementations of FIG. 2.

FIG. 11 is a high-level logic flowchart of a process.

FIG. 12 is a high-level logic flowchart depicting alternate implementations of FIG. 11.

FIG. 13 is a high-level logic flowchart depicting alternate implementations of FIG. 11.

FIG. 14 is a high-level logic flowchart depicting alternate implementations of FIG. 11.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

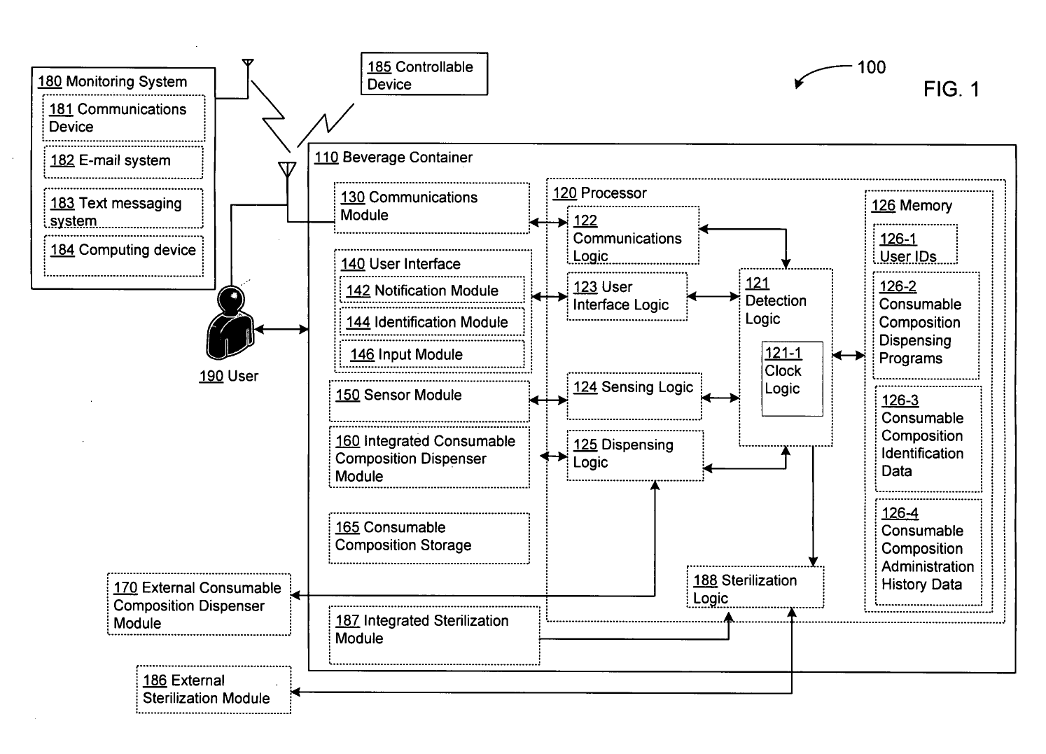

FIG. 1 illustrates an example environment in which one or more technologies may be implemented. A consumable composition dispensing system 100 may comprise a beverage container 110 to be used by user 190. The beverage container 110 may be any receptacle configured for retaining a liquid or gel composition. For example, the beverage container 110 may include a cup, glass, mug, bowl, pitcher, jug, or the like.

The beverage container 110 may include a processor 120 (e.g. a microprocessor), a communications module 130 (e.g. a cellular transceiver, a Bluetooth transceiver, a WiFi transceiver, a satellite transceiver), a user interface 140 (e.g. display, touch screen, keypad, speaker system), a sensor module 150 (e.g. a thermometer, barometer, concentration sensor, biometric sensor, accelerometer, electromagnetic sensor, acoustical sensor) an integrated consumable composition dispenser module 160 (e.g. injector, mechanical dispenser) and/or an integrated sterilization module 187 (e.g. a heating element).

The integrated consumable composition dispenser module 160 may be physically incorporated as a component of the beverage container 110. The integrated consumable composition dispenser module 160 may include an actuated mechanical apparatus which opens in response to a command from dispensing logic 125, thereby dispensing a dose of the consumable composition. The beverage container 110 may be configured to receive a dose of the consumable composition via gravitational flow or by pressurized injection of the dispensed composition from the integrated consumable composition dispenser module 160.

The external consumable composition dispenser module 170 may be physically separated from the beverage container 110. The external consumable composition dispenser module 170 may include a mechanical apparatus which opens in response to a command from dispensing logic 125 so as to introduce a dose of the consumable composition into the beverage container 110. The beverage container 110 may be configured to receive a dose of the consumable composition via a communicating assembly whereby the beverage container 110 may be physically coupled to the external consumable composition dispenser module 170 via a mutual conduit operably configured to allow the passage of the consumable composition between the external consumable composition dispenser module 170 and the beverage container 110.

Processor 120 may include communications logic 122, user interface logic 123, sensing logic 124, dispensing logic 125, memory 126, and/or sterilization logic 188.

Memory 126 may include user IDs 126-1 (e.g. user fingerprint data), consumable composition dispensing programs 126-2 (e.g. scheduled dosing regimens), consumable composition identification data 126-3 (e.g. spectroscopic data for various consumable compositions), and/or consumable composition administration history data 126-4 (e.g. timing data regarding dispensation and/or ingestion of consumable compositions).

User interface 140 may include a notification module 142 (e.g. an LED), an identification module 144 (a fingerprint scanner), and/or an input module 146 (a microphone).

Sensor module 150 may include one or more of a light source sensor, a position sensor, an emission sensor, a spectrophotometer, an infrared or ultraviolet sensor, a biometric sensor or the like. Sensor module 150 may include a biometric sensor which senses the presence of saliva, perspiration, sebum or the like, either on the surface of the beverage container 110 or as a component of the contents therein. Sensor module 150 may include an accelerometer, an inertial motion sensor, or the like, which may sense the movement of the beverage container 110. Sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, or the like which senses a pressure applied to the beverage container 110. Sensor module 150 may include a capacitive concentration sensor which may sense a concentration of the consumable composition present in the beverage container 110. Sensor module 150 may include an inclinometer or the like. Sensor module 150 may include a flow meter for sensing a flow rate into or out of the beverage container 110. Sensor module 150 may include a capacitive level sensor, such as a strip or dual-probe sensor (e.g., a strip running down that side of the cup to sense a fluid level based at least in part between differences in the known/inferred/assumed dielectric constants of air and a fluid). In some instances, the dielectric constant is recalled/calculated in response to a sensed composition of a fluid (e.g., sensed constituents of an alcoholic cocktail); in other instances, the dielectric constant is assumed (e.g., defaults to that of water). Sensor module 150 may include an electrochemical analyzer (e.g. an electrode pair disposed within an electrolyte capable of measuring an electrochemical reaction) for calculating a concentration of a gas in an atmosphere. Sensor module 150 may include a chemical composition analysis mechanism (e.g. photoionization sensors, spectroscopic sensors, spectrometric sensors, crystallographic sensors, electrochemical sensors, calorimetric sensors).

The consumable composition dispensing system 100 may further include an external consumable composition dispenser module 170 (e.g. injector, mechanical dispenser) and/or external sterilization module 186 (e.g. an autoclave).

Monitoring system 180 may relay a notification (e.g. a notification that a chemical interaction between two or more consumable compositions may occur) received from communications module 130 to a communications device 181 (e.g. a cell phone, satellite phone, Blackberry®, and/or land-line phone), e-mail system 182 (e.g. an IMAP, POP3, SMTP, and/or HTTP e-mail server having an e-mail account associated with a user 190), text messaging system 183 (e.g. SMS system in GSM) and/or a computing device 184 (e.g. a personal digital assistant (PDA), personal computer, laptop, music player and/or gaming device).

The consumable composition may be a pharmaceutical composition including, but not limited to, one or more of the following: 5-alpha reductase inhibitors, 5-HT antagonists, ACE inhibitors, adrenergic agonists, adrenergic neurone blockers, alkalising agent, alpha blockers, aminoglycosides, anaesthetics, analgesics, androgens, angiotensin receptor blockers, anti-allergics, antiandrogens, antianginals, antiarrhythmics, antibiotics, anticholinergics, anticholinesterase, anticoagulants, anticonvulsants, antidepressants, antidiarrhoeals, antidopaminergics, anti-emetics, antiepileptics, antiflatulents, antifungal, antifungals, anti-hemophilics, antihistamine, antihistamines, antiplatelets, antipsychotics, antiseptics, antispasmodic, antispasmodics, antithyroid drugs, antitussives, anxiolytics, astringents, barbiturates, benzodiazepine, beta-receptor antagonists, beta-receptor blocker, bile acid sequestrants, bronchodilators, calcitonins, calcium channel blockers, cannabinoids, carbonic anhydrase inhibitors/hyperosmotics, cardiac glycosides, cerumenolyti, cholinergics, corticosteroids, COX-2 selective inhibitors, cycloplegics, cyclopyrrolone, cytoprotectants, decongestants, diphosphonates, diuretics, dopamine antagonist, emetic, fibrinolytics, fluoroquinolones, gonadotropins, growth hormones, H2-receptor antagonists, haemostatic drugs, heparins, hormonal contraceptives, hypnotics, hypolipidaemic agents, imidazoles, immunoglobulins, immunosuppressants, insulin, interferons, laxatives, local anesthetics, mast cell inhibitors, miotics, monoclonal antibodies, movement disorder drugs, mucolytics, muscle relaxants, mydriatics, neuromuscular drugs, nitrates, nitroglycerin, NSAIDs, ocular lubricants, opioids, parasympatholytics, parasympathomimetics, peripheral activators, polyenes, prostaglandin agonists/prostaglandin inhibitors, prostaglandin analogues, proton pump inhibitors, quinolones, reflux suppressants, selective alpha-1 blocker, sildenafil, statins, steroids, stimulants, sulfa drugs, sympathomimetics, thyroid hormones, topical anesthetics, topical antibiotics, vaccines, vasoconstrictors, vasodilators, vasopressin analogues, or the like.

The consumable composition may be a neutraceutical composition including, but not limited to, one or more of the following: vitamins (e.g., ascorbic acid, pyridoxine, riboflavin), minerals (e.g., calcium salts, zinc salts, potassium salts), hormones (e.g., dimethylaminoethanol (DMAE), dehydroepiandrosterone (DHEA), melatonin), biochemicals (e.g., adenosine triphosphate, coenzyme A, cysteine), glandulars (e.g., edible compositions derived from glandular organs of animals such as the thyroid, pancreas, adrenal cortex), herbals (e.g., ginkgo, garlic, goldenseal, Echinacea), or the like.

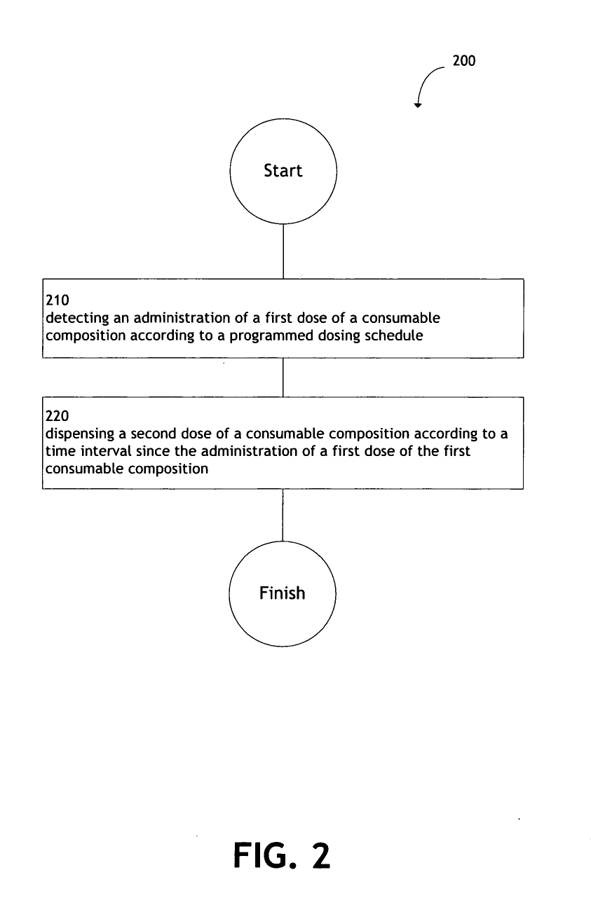

FIG. 2 illustrates an operational flow 200 representing example operations related to programmed dispensing of consumable compositions. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

Operation 210 depicts detecting an administration of a first dose of a consumable composition according to a programmed dosing schedule. For example, as shown in FIG. 1, an administration (e.g. a dispensation of a dose of a consumable composition by the integrated consumable composition dispenser module 160 and/or the external consumable composition dispenser module 170; an ingestion of the consumable composition by user 190) of a consumable composition according to a programmed dosing schedule (e.g. a dosing regimen stored as consumable composition dispensing programs 126-2) may be detected by detection logic 121 receiving data from dispensing logic 125 operably coupled to dispensing logic 125 and/or sensing module 150 operably coupled sensing logic 124. The detection of an administration of a consumable composition may cause the detection logic 121 to store a current time value maintained by clock logic 121-1 as consumable composition administration history data 126-4 in memory 126.

Operation 220 depicts dispensing a second dose of a consumable composition according to a time interval since the administration of a first dose of the first consumable composition (e.g. distributing a pharmaceutical composition in accordance with a timed regimen). For example, as shown in FIG. 1, the detection logic may detect a time interval that has elapsed since an administration of a dose of a consumable composition by comparing a current time as maintained by the clock logic 121-1 with consumable composition administration history data 126-4. The detection logic 121 may compare the time interval to recommended timings of doses of one or more consumable compositions (e.g. consumable composition dispensing programs 126-2) or time-dependent interactions of one or more consumable compositions (e.g. contraindication data stored as consumable composition identification data 126-3) and cause the dispensing logic 125 to cause the integrated consumable composition dispenser module 160, and/or an external consumable composition dispenser module 170 to distribute one or more doses (e.g. 30 mg) of a consumable composition (e.g., an anti-depressant, such as Paroxotene) into the beverage container 110 (e.g., a drinking cup) according to the time interval. It should be noted that the second dose of a consumable composition may include a consumable composition different than the first dose of a consumable composition and/or a second dose of the first consumable composition.

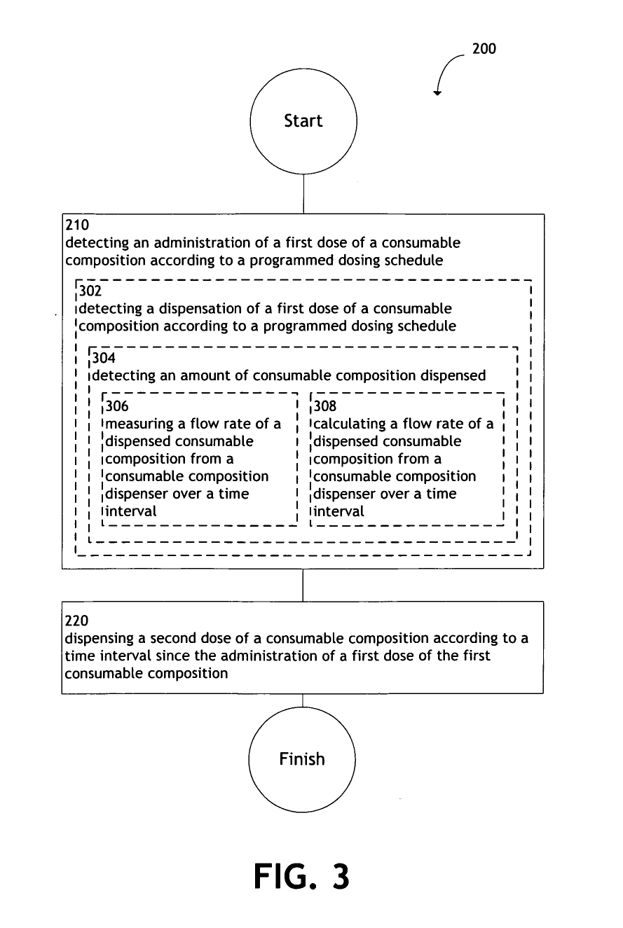

FIG. 3 illustrates an example embodiment where the operation 210 of the example operational flow 200 of FIG. 2 may include at least one additional operation. Additional operations may include an operation 302, an operation 304, an operation 306, and/or an operation 308.

FIG. 3 shows that Operation 210, detecting an administration of a first dose of a consumable composition according to a programmed dosing schedule, may in some instances include Operation 302. Operation 302 illustrates detecting a dispensation of a first dose of a consumable composition according to a programmed dosing schedule. For example, as shown in FIG. 1, a dispensation of a dose of a consumable composition may be detected (e.g. detection of a logical flag set by dispensing logic 125 upon dispensation of a consumable composition) by detection logic 121 receiving data from the integrated consumable composition dispenser module 160 and/or the external consumable composition dispenser module 170 operably coupled to dispensing logic 125. A detected dispensation of a consumable composition may cause the detection logic 121 to store a current time value maintained by clock logic 121-1 as consumable composition administration history data 126-4 in memory 126.

FIG. 3 shows that Operation 302, detecting a dispensation of a first dose of a consumable composition according to a programmed dosing schedule, may in some instances include Operation 304. Operation 304 illustrates detecting an amount of consumable composition dispensed (e.g. detecting a flow rate, mass, volume, concentration, and the like, of a consumable composition). For example, as shown in FIG. 1, an amount of the consumable composition dispensed by the integrated consumable composition dispenser module 160 and/or the external consumable composition dispenser module 170 may be detected by detection logic 121 receiving data from a sensing module 150 operably coupled to sensing logic 124. The dispensation detected in Operation 302 may be used in detecting an administration of a first dose of a consumable composition (Operation 210). For instance, a detected dispensation may be indicative of a completion of an administration of a dose of consumable composition and the consumable composition dispensing system 100 may then proceed to subsequent administrations.

FIG. 3 shows that Operation 304, detecting an amount of consumable composition dispensed, may in some instances include Operation 306. Operation 306 illustrates measuring a flow rate of a dispensed consumable composition from a consumable composition dispenser over a time interval (e.g. a rate at which a physical, chemical, electrical, or optical property changes). For example, as shown in FIG. 1, an amount of consumable composition dispensed by the integrated consumable composition dispenser module 160 and/or the external consumable composition dispenser module 170 may be detected by measuring a flow rate of the consumable composition dispensed over a period of time with the sensor module 150 (e.g. a fiber optic pressure/outflow sensor, mechanical deflection pressure/outflow sensor, strain gauge pressure/outflow sensor, piezoresistive pressure/outflow sensor, microelectromechanical (M EMS) pressure/outflow sensor, variable capacitance pressure/outflow sensor, flow meters, and the like). The flow rate measured in Operation 306 may be used in detecting an amount of consumable composition dispensed (Operation 304). For instance, the product of the measured flow rate and the time interval may be computed so as to detect an amount of consumable composition dispensed.

FIG. 3 shows that Operation 304, detecting an amount of consumable composition dispensed, may in some instances include Operation 308. Operation 308 illustrates calculating a flow rate of a dispensed consumable composition from a consumable composition dispenser over a time interval. For example, as shown in FIG. 1, the sensor module 150 may detect a volumetric flow rate of consumable composition contained in consumable composition storage 165 (e.g. a magnetic flow meter measuring volume outflow from the consumable composition storage 165 over time), a mass flow rate of consumable composition contained in consumable composition storage 165 (e.g. a piezoresistive pressure sensor measuring the change in the force associated with the mass present in the consumable composition storage 165 over time), and the like. The flow rate calculated in Operation 308 may be used in detecting an amount of consumable composition dispensed (Operation 304). For instance, the product of the calculated flow rate and the time interval may be computed so as to detect an amount of consumable composition dispensed.

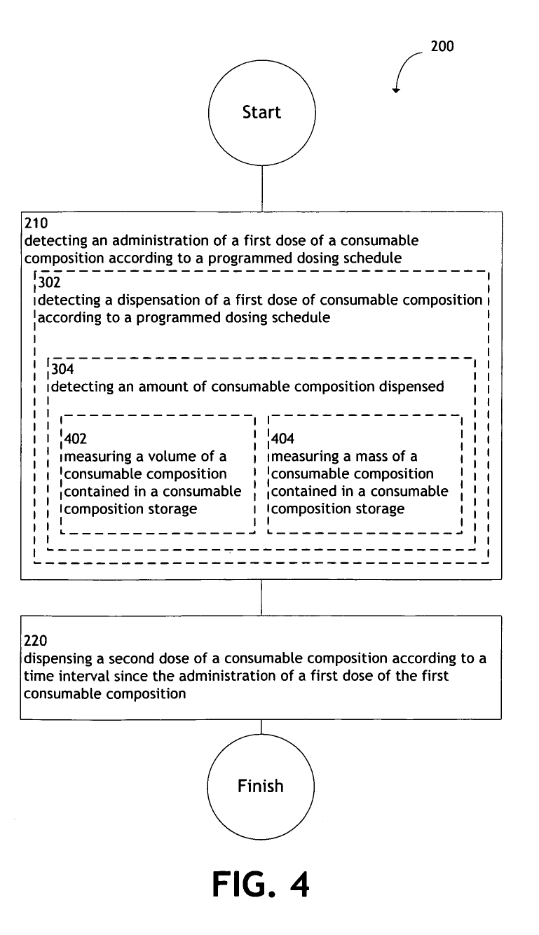

FIG. 4 illustrates an example embodiment where the operation 304 of example operational flow 200 of FIG. 3 may include at least one additional operation. Additional operations may include an operation 402, and/or an operation 404.

FIG. 4 shows that Operation 304, detecting an amount of consumable composition dispensed, may in some instances include Operation 402. Operation 402 illustrates measuring a volume of a consumable composition contained in a consumable composition storage (e.g. optical and/or acoustical detection of a level of a consumable composition within a container). For example, as shown in FIG. 1, the sensor module 150 may be an optical and/or acoustical sensor module. The optical and/or acoustical sensor module 150 may emit one or more forms of electromagnetic radiation (EMR) and/or acoustical waves which may be reflected by one or more surfaces of the consumable composition maintained within the consumable composition storage 165. The transmit/receive time of the reflected EMR and/or acoustical waves may be translated into a distance the surface of consumable composition is away from the sensor module 150. A known positional relationship of the sensor 150 with respect to the consumable composition storage 165 and the dimensions of the consumable composition storage 165 may allow for the calculation of the volume of the consumable composition contained in the consumable composition storage 165. The volume of consumable composition measured in Operation 402 may be used in detecting an amount of consumable composition dispensed (Operation 304). For instance, the volume of the consumable composition within the composition storage 165 and the physical characteristics of the consumable composition (e.g. density data, concentration data, and the like, maintained as consumable composition identification data 126-3) may allow for the calculation of an amount of consumable composition.

FIG. 4 shows that Operation 304, detecting an amount of consumable composition dispensed, may in some instances include Operation 404. Operation 404 illustrates measuring a mass of a consumable composition contained in a consumable composition storage (e.g. mechanical deflection pressure detection). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor, and the like) may detect a force exerted by the mass of a consumable composition within the consumable composition storage 165. The force exerted by the consumable composition as measured in Operation 404 may be used in detecting an amount of consumable composition dispensed (Operation 304). For instance, the sensing logic 124 may receive the force data and calculate an associated mass of the consumable composition contained in the consumable composition storage 165 based on the force data and known physical properties of the consumable composition as maintained in consumable composition identification data 126-3.

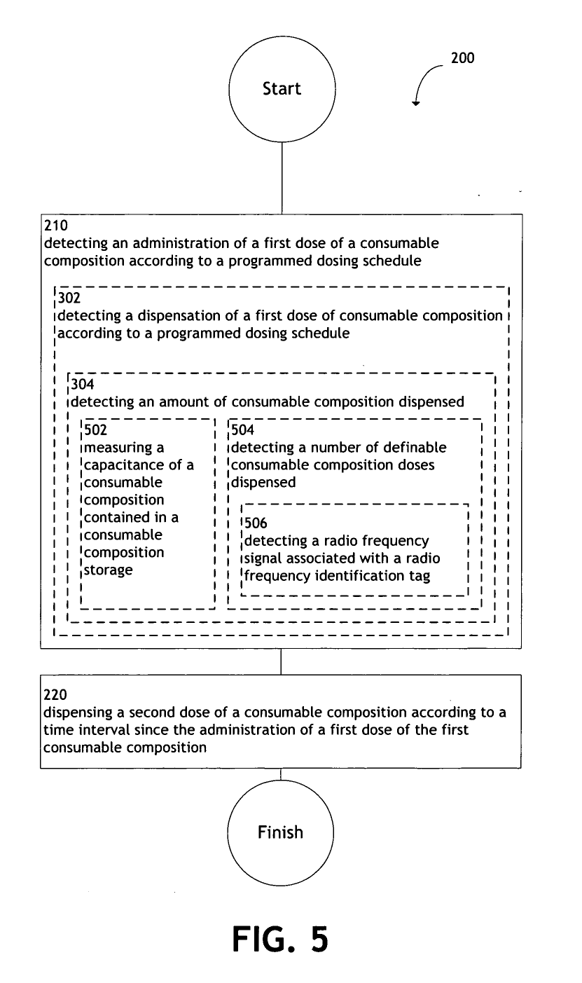

FIG. 5 illustrates an example embodiment where the operation 304 of example operational flow 200 of FIG. 3 may include at least one additional operation. Additional operations may include an operation 502, an operation 504 and/or an operation 506.

FIG. 5 shows that Operation 304, detecting an amount of consumable composition dispensed, may in some instances include Operation 502. Operation 502 illustrates measuring a capacitance of a consumable composition contained in a consumable composition storage (e.g. calculating a concentration of a consumable composition from a detection of a capacitance of a consumable composition). For example, as shown in FIG. 1, a chemical field effect transistor sensor module 150 may sense a capacitance of a consumable composition maintained in the consumable composition storage 165. The capacitance may be correlated to a corresponding concentration (e.g. a lookup table relating a detected capacitance to a concentration and maintained as consumable composition identification data 126-3). The concentration of consumable composition measured in Operation 502 may be used in detecting an amount of consumable composition dispensed (Operation 304). For instance, detection logic 121 may calculate an amount of consumable composition dispensed by looking up capacitance and a known capacitance/concentration correlation (e.g. consumable composition identification data 126-3 representing a capacitance/concentration correlations) to detect a concentration of the consumable composition contained in the consumable composition storage 165.

FIG. 5 shows that Operation 304, detecting an amount of consumable composition dispensed, may in some instances include Operation 504. Operation 504 illustrates detecting a number of definable consumable composition doses dispensed (e.g. detecting a number of pills dispensed). For example, as shown in FIG. 1, the sensor module 150 may sense (e.g. motion sensing) a dispensation of a consumable composition formulated in a defined structure having a known dosage amount (e.g. a pill-type structure) by the integrated consumable composition dispenser module 160 and/or the external consumable composition dispenser module 170. The number of definable doses of consumable composition detected in Operation 504 may be used in detecting an amount of consumable composition dispensed (Operation 304). For instance, the detection logic 121 may calculate an amount of consumable composition dispensed by computing a product of the dosage amount of each pill (e.g. consumable composition identification data 126-3) and a number of pills detected as having been dispensed.

FIG. 5 shows that Operation 504, detecting a number of definable consumable composition doses dispensed, may in some instances include Operation 506. Operation 506 illustrates detecting a radio frequency signal associated with a radio frequency identification tag (e.g. detecting a presence and/or absence of a passive, semi-passive and/or active RFID tag). For example, as shown in FIG. 1, the sensor module 150 may include a radio frequency (RF) sensor which may transceive RF signals. The radio frequency signal associated with the RFID tag detected in Operation 506 may be used in detecting a number of definable consumable composition doses dispensed (Operation 504). For instance, the sensor module 150 may sense dispensation of a consumable composition formulated in a definable dose (e.g. a pill-type structure) having a known dosage amount (e.g. as maintained as consumable composition identification data 126-3) by the integrated consumable composition dispenser module 160 and/or the external consumable composition dispenser module 170 by monitoring the presence and/or absence of RF signals associated with an RFID tag (e.g. a passive, semi-passive and/or active RFID tag) included in the consumable composition.

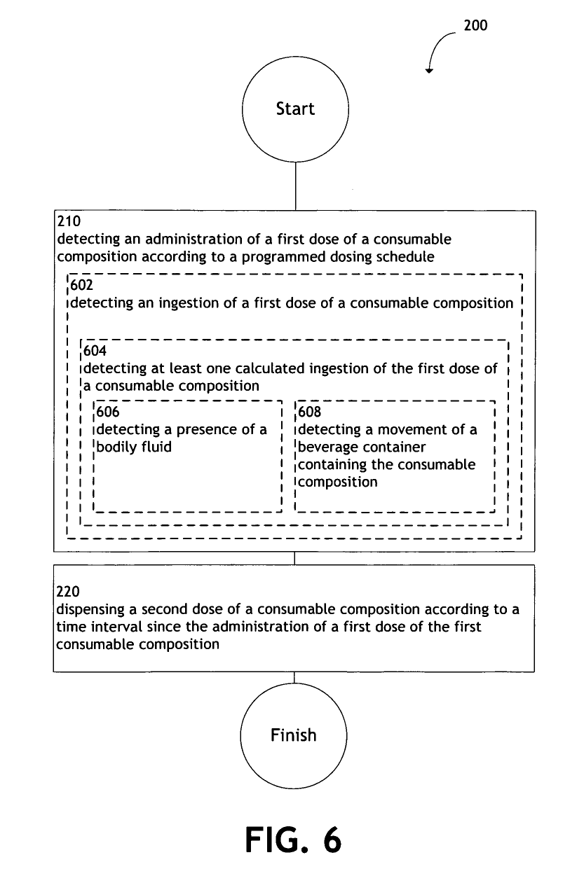

FIG. 6 illustrates an example embodiment where the operation 210 of example operational flow 200 of FIG. 2 may include at least one additional operation. Additional operations may include an operation 602, an operation 604, an operation 606 and/or an operation 608.

FIG. 6 shows that Operation 210, detecting an administration of a first dose of a consumable composition according to a programmed dosing schedule, may in some instances include Operation 602. Operation 602 illustrates means for detecting an ingestion of a first dose of a consumable composition. For example, as shown in FIG. 1, an ingestion of a dose of a consumable composition may be detected by detection logic 121 receiving data from a sensing module 150 (e.g. a biometric sensor) operably coupled to sensing logic 124. An indicated ingestion detected by sensing module 150 may cause detection logic 121 to store a current time value (e.g. a time maintained by clock logic 121-1) associated with the ingestion as consumable composition administration history data 126-4. The stored timer value may be compared to a current timer value maintained by clock logic 121-1 so as to calculate and elapsed time interval following an ingestion. The ingestion detected in Operation 602 may be used in detecting an administration of a first dose of a consumable composition (Operation 210). For instance, a detected ingestion may be indicative of a completion of an administration of a dose of consumable composition and the consumable composition dispensing system 100 may then proceed to subsequent administrations.

FIG. 6 shows that Operation 602, means for detecting an ingestion of a first dose of a consumable composition, may in some instances include Operation 604. Operation 604 illustrates detecting at least one calculated ingestion of the first dose of a consumable composition (e.g. detecting that one or more events have occurred indicating a likelihood that a user has complied with a programmed dosing schedule for the consumable composition by swallowing the consumable composition). For example, as shown in FIG. 1, the sensing logic 124 may be operably coupled to sensor module 150. The sensor module 150 may detect environmental conditions (e.g. movement of a consumable composition within a beverage container 110, chemical compositions present within the consumable composition or on the beverage container 110, and the like). The calculated ingestion of the consumable composition and the second consumable composition as detected in Operation 604 may be used in detecting an ingestion of a consumable composition (Operation 602). For instance, the detected environmental conditions may indicate a likelihood of an ingestion of a consumable composition by the user 190, rather than directly detecting characteristics of the consumable composition itself.

FIG. 6 shows that Operation 604, detecting at least one calculated ingestion of the first dose of a consumable composition, may in some instances include Operation 606. Operation 606 illustrates detecting a presence of a bodily fluid (e.g. biometric detection). For example, as shown in FIG. 1, the sensor module 150 may include a biometric sensor (e.g. an amperometric glucose sensor) which senses the presence of saliva, perspiration, sebum and the like, either on the surface of the beverage container 110 or as a component of the contents therein. The presence of a bodily fluid measured in Operation 606 may be used in detecting a calculated ingestion of a consumable composition (Operation 604). For instance, the presence of biological material may indicate a likelihood that the beverage container 110 has been physically contacted by user 190 (e.g. the mouth of user 190) indicating an ingestion of a consumable composition.

FIG. 6 shows that Operation 604, detecting at least one calculated ingestion of the first dose of a consumable composition, may in some instances include Operation 606. Operation 608 illustrates detecting a movement of a beverage container containing the consumable composition (e.g. accelerometric detection of a user-initiated movement). For example, as shown in FIG. 1, the sensor module 150 may include an accelerometer, inertial motion sensor and the like, which may sense the movement of the beverage container 110. The movement of a beverage container as measured in Operation 608 may be used in detecting a calculated ingestion of a consumable composition (Operation 604). The movement of the beverage may be correlated to movement required to positioning of the beverage container 110 into a position indicative of a likely ingestion of the consumable composition by user 190 (e.g. a drinking position).

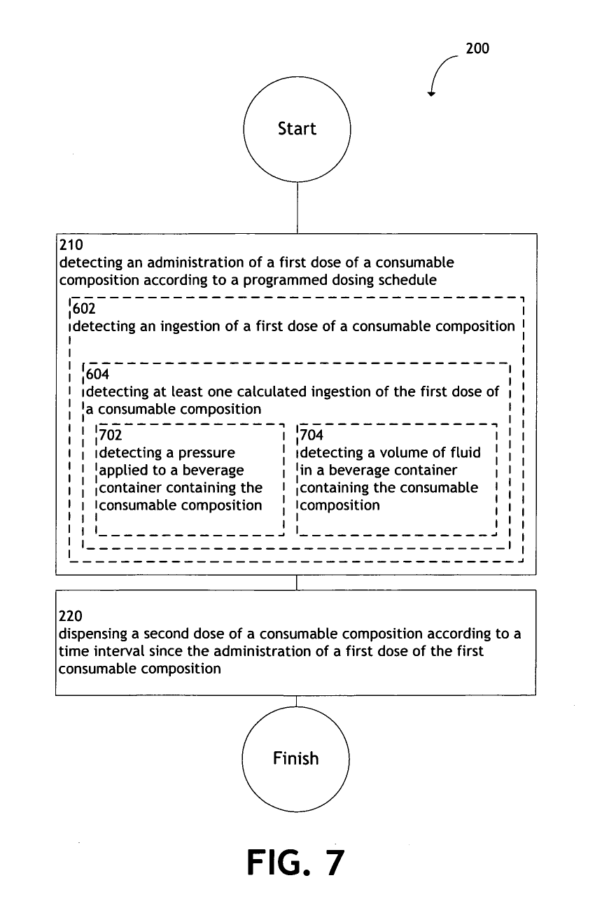

FIG. 7 illustrates an example embodiment where the operation 604 of example operational flow 200 of FIG. 6 may include at least one additional operation. Additional operations may include an operation 702, and/or an operation 704.

FIG. 7 shows that Operation 604, detecting at least one calculated ingestion of the first dose of a consumable composition, may in some instances include Operation 702. Operation 702 illustrates detecting a pressure applied to a beverage container containing the consumable composition (e.g. fiber optic pressure detection of a user grasping the beverage container). For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110. The pressure applied to the beverage container 110 as measured in Operation 702 may be used in detecting a calculated ingestion of a consumable composition (Operation 604). For instance, a detected pressure applied to the beverage container 110 may be correlated to a pressure required to grip the beverage container 110 such that the consumable composition may be ingested by user 190, thereby indicating a likelihood of ingestion.

FIG. 7 shows that Operation 604, detecting at least one calculated ingestion of the first dose of a consumable composition, may in some instances include Operation 704. Operation 704 illustrates detecting a volume of fluid in a beverage container containing the consumable composition (e.g. optical and/or acoustical detection of a level of a consumable composition within a container). For example, as shown in FIG. 1, the sensor module may include an optical and/or acoustical sensor module. The sensor module may emit one or more forms of electromagnetic radiation (EMR) and/or acoustic waves which may be reflected by one or more surfaces of the consumable composition maintained within the consumable composition storage 165. The transmit/receive time of the reflected EMR and/or acoustic wave may be translated into the distance the level of consumable composition is away from the sensor module 150 (e.g. the level of the consumable composition). A known positional relationship of the sensor 150 with respect to the consumable composition storage 165 and the dimensions of the consumable composition storage 165 allow for the calculation of the volume of the consumable composition contained in the consumable composition storage 165. The detected volume of fluid in the beverage container 110 as measured in Operation 704 may be used in detecting a calculated ingestion of a consumable composition (Operation 604). For instance, a change in the detected volume of fluid in the beverage container 110 may be indicative of the likelihood of an ingestion of the consumable composition by a user 190.

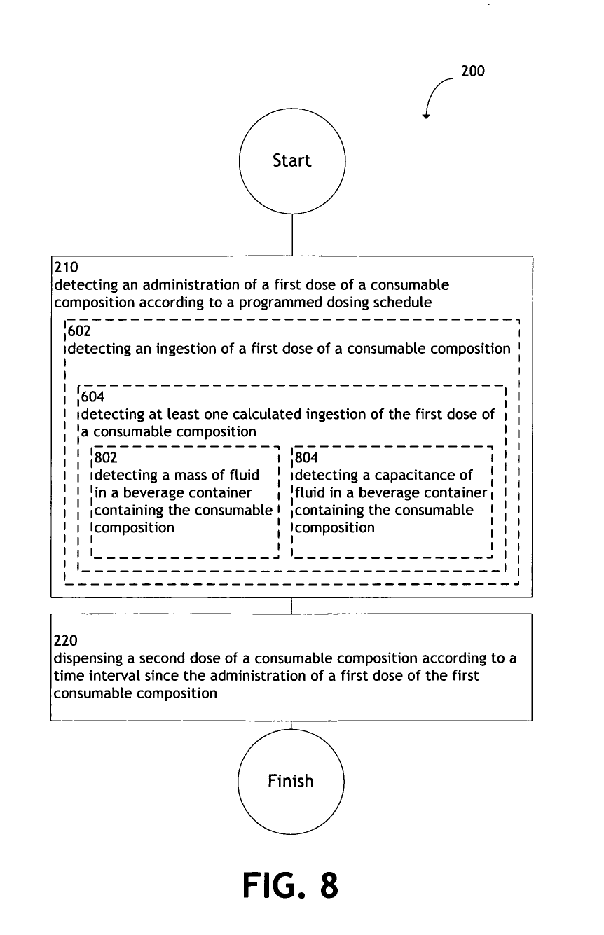

FIG. 8 illustrates an example embodiment where the operation 604 of example operational flow 200 of FIG. 6 may include at least one additional operation. Additional operations may include an operation 802, and/or an operation 804.

FIG. 8 shows that Operation 604, detecting at least one calculated ingestion of the first dose of a consumable composition, may in some instances include Operation 802. Operation 802 illustrates detecting a mass of fluid in a beverage container containing the consumable composition (e.g. mechanical deflection pressure detection). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor) may detect a force exerted by the mass of a consumable composition within the consumable composition storage 165. The sensing logic 124 may receive the force data and calculate an associated mass of the consumable composition contained in the consumable composition storage 165 based on the force data and known physical properties of the consumable composition as maintained in consumable composition identification data 126-3. The detected mass of fluid in the beverage container 110 as measured in Operation 802 may be used in detecting a calculated ingestion of a consumable composition (Operation 604). For instance, a change in the detected mass of fluid in the beverage container 110 may be indicative of the likelihood of an ingestion of the consumable composition by a user 190.

FIG. 8 shows that Operation 604, detecting at least one calculated ingestion of the first dose of a consumable composition, may in some instances include Operation 804. Operation 804 illustrates detecting a capacitance of fluid in a beverage container containing the consumable composition (e.g. calculating a concentration of a consumable composition from a detection of a capacitance of a consumable composition). For example, as shown in FIG. 1, a chemical field effect transistor sensor module 150 may sense a capacitance of a consumable composition maintained in the consumable composition storage 165. The capacitance may be correlated to a corresponding concentration (e.g. a lookup table relating detected capacitance to a concentration and maintained as consumable composition identification data 126-3). The concentration and the known dimensions of the consumable composition storage 165 may allow for the calculation of the amount of consumable composition contained in the consumable composition storage 165. The detected capacitance of fluid in the beverage container 110 as measured in Operation 804 may be used in detecting a calculated ingestion of a consumable composition (Operation 604). For instance, a change in the detected capacitance of fluid in the beverage container 110 may be indicative of the likelihood of an ingestion of the consumable composition by a user 190.

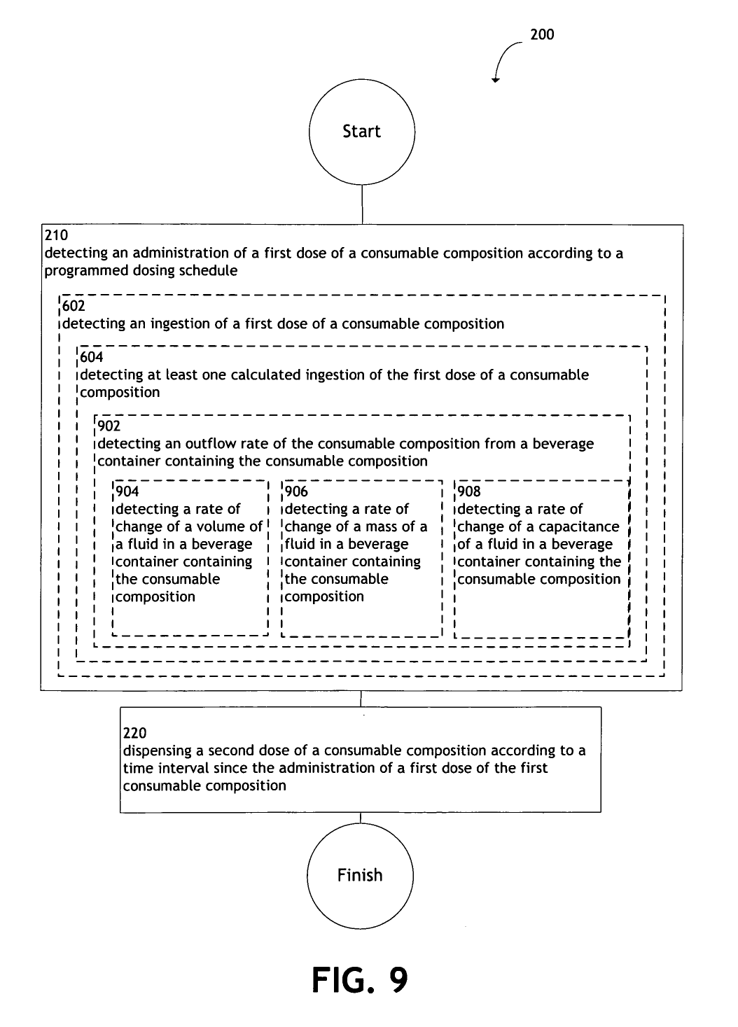

FIG. 9 illustrates an example embodiment where the operation 604 of example operational flow 200 of FIG. 6 may include at least one additional operation. Additional operations may include an operation 902, an operation 904, an operation 906 and/or an operation 908.

FIG. 9 shows that Operation 604, detecting at least one calculated ingestion of the first dose of a consumable composition, may in some instances include Operation 902. Operation 902 illustrates detecting an outflow rate of the consumable composition from a beverage container containing the consumable composition (e.g. a rate at which a physical, chemical, electrical, or optical property changes). For example, as shown in FIG. 1, the sensor module 150 may include a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flow meters, and the like, which sense an outflow from the beverage container 110 containing the consumable composition. The detected outflow rate of the consumable composition from the beverage container 110 as detected in Operation 902 may be used in detecting a calculated ingestion of a consumable composition (Operation 604). For instance, an outflow may indicate a proper ingestion or an improper disposal of the consumable composition, depending on the outflow rate. For example, proper ingestion might be indicated by an outflow rate indicative of normal drinking (e.g. 50 ml per second), while improper disposal might be indicated by an outflow rate indicative of rapidly dumping the contents of the cup by upending the cup (e.g. 500 ml per second).

FIG. 9 shows that Operation 902, detecting an outflow rate of the consumable composition from a beverage container containing the consumable composition, may in some instances include Operation 904. Operation 904 illustrates detecting a rate of change of a volume of a fluid in a beverage container containing the consumable composition (e.g. an optical and/or acoustical sensor measuring a change in a volume of fluid within the beverage container 110 over time). For example, as shown in FIG. 1, the sensor module 150 may be an optical and/or acoustic sensor module. The sensor module may emit one or more forms of electromagnetic radiation (EMR) and/or acoustical waves which may be reflected by one or more surfaces of the consumable composition maintained within the consumable composition storage 165. The transmit/receive time of the reflected EMR and/or acoustical wave may be translated into a distance the surface of consumable composition is away from the sensor module 150. A known positional relationship of the sensor 150 with respect to the consumable composition storage 165 and the dimensions of the consumable composition storage 165 may allow for the calculation of the volume of the consumable composition contained in beverage container. The sensor module may detect a first volume of fluid within the beverage container 110. At a later time, the sensor module 150 may detect a second volume of fluid. The sensing logic 124 may receive the EMR and/or acoustical wave data from the sensor module 150 and calculate the associated volume of the consumable composition contained in the beverage container 110 at both the first detection and the second detection. A rate of change of volume of the fluid in the beverage container 110 may be calculated from the difference in volume over the time period. The detected change in volume of the fluid in the beverage container 110 as detected in Operation 904, may be used in detecting the outflow rate of a consumable composition (Operation 902). For instance, the change in mass of the fluid over the time period and the concentration of the consumable composition within the fluid may be used to calculate the outflow of consumable composition from the beverage container 110.

FIG. 9 shows that Operation 902, detecting an outflow rate of the consumable composition from a beverage container containing the consumable composition, may in some instances include Operation 906. Operation 906 illustrates detecting a rate of change of a mass of a fluid in a beverage container containing the consumable composition (e.g. a piezoresistive pressure sensor measuring the change in the mass present in a beverage container over time). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor) may detect a first force exerted by the mass of a fluid within the beverage container 110. At a later time, the sensor module 150 may detect a second force exerted by the mass of a fluid within the beverage container. The sensing logic 124 may receive the force data and calculate the associated mass of the fluid contained in the beverage container 110 at both the first detection and the second detection. A rate of change of mass of the consumable composition may be calculated from the difference in mass over the time period. The detected change in mass of the fluid in the beverage container 110 as detected in Operation 906, may be used in detecting the outflow rate of a consumable composition (Operation 902). For instance, the change in mass of the fluid, density of the fluid and the concentration of the consumable composition within the fluid may be used to calculate the outflow of consumable composition from the beverage container 110.

FIG. 9 shows that Operation 902, detecting an outflow rate of the consumable composition from a beverage container containing the consumable composition, may in some instances include Operation 908. Operation 908 illustrates detecting a rate of change of a capacitance of a fluid in a beverage container containing the consumable composition (e.g. calculating a capacitance associated with the presence of a consumable composition within a fluid containing the consumable composition). For example, as shown in FIG. 1, the sensor module 150 (e.g. a chemical field effect transistor sensor) may sense a first capacitance of a consumable composition maintained in the beverage container 110. At a later time, the sensor module 150 may detect a second capacitance of the consumable composition within the beverage container 110. The sensing logic 124 may receive the capacitance data and calculate a rate of change of capacitance of the fluid within the beverage container as the difference in capacitance over the time period. The detected change in capacitance of the consumable composition from the beverage container 110 as detected in Operation 908, may be used in detecting the outflow rate of a consumable composition (Operation 902). For instance, the change in capacitance of the fluid and the concentration of the consumable composition within the fluid (e.g. a detected concentration) may be used to calculate the outflow of consumable composition from the beverage container 110

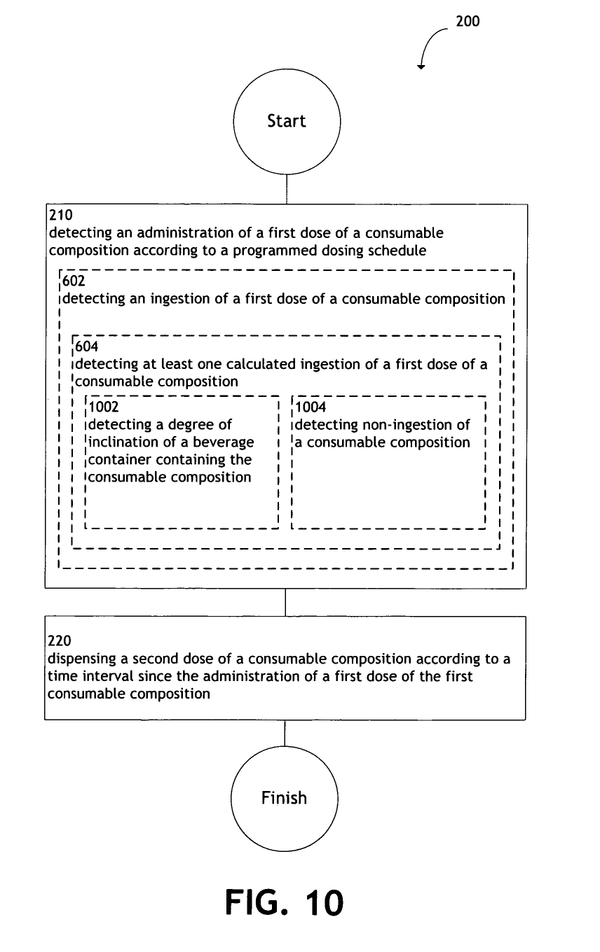

FIG. 10 illustrates an example embodiment where the operation 604 of example operational flow 200 of FIG. 6 may include at least one additional operation. Additional operations may include an operation 1002 and/or an operation 1004.

FIG. 10 shows that Operation 604, detecting at least one calculated ingestion of the first dose of a consumable composition, may in some instances include Operation 1002. Operation 1002 illustrates detecting a degree of inclination of a beverage container containing the consumable composition (e.g. detecting that a user is rotating the beverage container by a certain degree relative to its designed resting position so as to ingest its contents). For example, as shown in FIG. 1, the sensor module 150 may include an inclinometer and the like. The detected inclination of the beverage container 110 as detected in Operation 1002 may be used in detecting a calculated ingestion of a consumable composition (Operation 604). For instance, the degree of incline of the beverage container 110 may indicate a proper ingestion (e.g. a rotation of less than or equal to 110 degrees may indicate proper ingestion) or an improper disposal (e.g. a rotation of greater than 110 degrees may indicate improper disposal) of the consumable composition, depending on the degree of incline.

FIG. 10 shows that Operation 604, detecting at least one calculated ingestion of the first dose of a consumable composition, may in some instances further include Operation 1004. Operation 1004 illustrates detecting non-ingestion of a consumable composition (e.g. a quantity of a consumable composition may be spilled from beverage container 110 prior to its ingestion by a user 190). For example, as shown in FIG. 1, the sensor module 150 may include a sensor (e.g. a piezoresistive pressure sensor) which may detect a pressure about an ingestion aperture of the beverage container 110 through which a user 190 may drink the consumable composition. The sensor module 150 may detect a pressure resulting from a flow of a consumable composition across portions of the ingestion aperture not associated with proper ingestion (e.g. simultaneous flow across opposite sides of a ingestion aperture) or variable flow rates (e.g. a flow across a first portion of the ingestion aperture has greater velocity that that across a second portion of the ingestion aperture) indicating spillage of the consumable composition across the ingestion aperture.

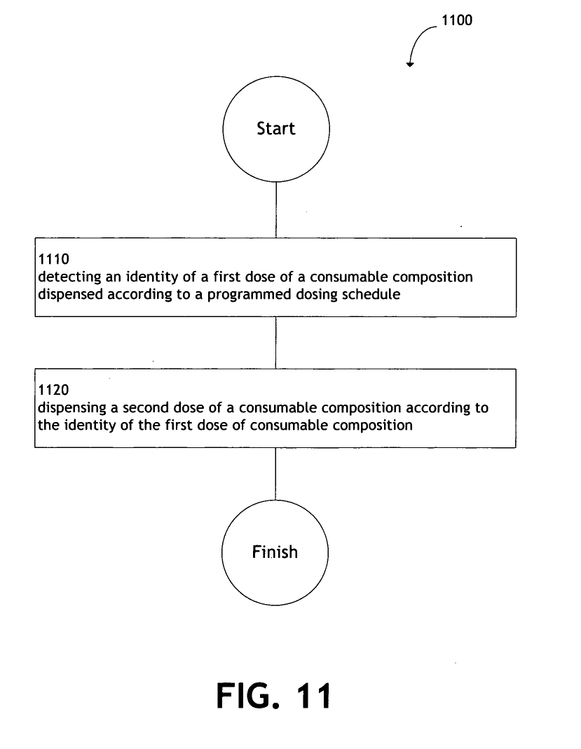

FIG. 11 depicts an operational flow 1100 representing example operations related to programmed dispensing of consumable compositions. After a start operation, the operational flow 1100 moves to an operation 1110 and/or an operation 1120.

Operation 1110 depicts detecting an identity of a first dose of a consumable composition dispensed according to a programmed dosing schedule (e.g. spectroscopic measurement of the composition of a biochemical). For example, as shown in FIG. 1, an integrated consumable composition dispenser module 160, and/or an external consumable composition dispenser module 170 may distribute one or more doses (e.g. 30 mg) of a consumable composition (e.g., an anti-depressant, such as Paroxotene) into a beverage container 110 (e.g., a drinking cup) according to a programmed dosing schedule (e.g. electronic data representing a dispensing regimen maintained in memory 126). Sensing logic 124 may cause sensor module 150 to detect an identity (e.g. a chemical composition) of a consumable composition. Sensor module 150 may include a chemical composition analysis mechanism (e.g. photoionization sensors, spectroscopic sensors, spectrometric sensors, crystallographic sensors, electrochemical sensors, calorimetric sensors). Identity data regarding the first dose of a consumable composition may be compared to consumable composition identification data 126-3 maintained in memory 126 so as to determine an identity of the first dose of a consumable composition.

Operation 1120 depicts dispensing a second dose of a consumable composition according to the identity of the first dose of a consumable composition (e.g. distributing a second pharmaceutical composition in accordance with contraindications associated with a first dose of a consumable composition). For example, as shown in FIG. 1, an integrated consumable composition dispenser module 160, and/or an external consumable composition dispenser module 170 may distribute one or more doses (e.g. 30 mg) of one or more consumable compositions (e.g., a vitamin B-12 supplement) into a beverage container 110 (e.g., a drinking cup) according to the identity of the one or more consumable compositions (e.g. electronic data representing consumable composition identification data 126-3). The second dose of the consumable composition may be dispensed at varying time intervals following the dispensation of various different first doses of consumable compositions depending on calculated relative chemical interactions and physiological effects between the second dose and various first doses (e.g. a narcotic and a sedative may be dispensed at a different time interval than a vitamin and the sedative).

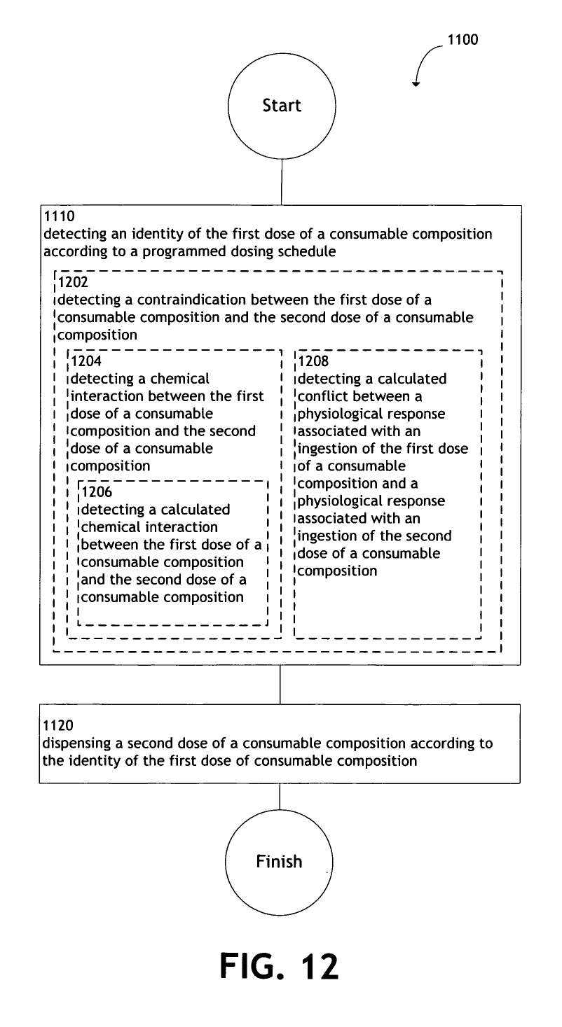

FIG. 12 illustrates an example embodiment where the operation 1110 of example operational flow 1100 of FIG. 11 may include at least one additional operation. Additional operations may include an operation 1202, an operation 1204, an operation 1206 and/or an operation 1208.

FIG. 12 shows that Operation 1110, detecting an identity of a first dose of a consumable composition dispensed according to a programmed dosing schedule, may in some instances further include Operation 1202. Operation 1202 illustrates detecting a contraindication between the first dose of a consumable composition and the second dose of a consumable composition (e.g. detecting a combination of consumable compositions which, when ingested within a proximate time period, may be harmful to a user). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which may be generally contraindicated for the first dose of consumable composition or specifically contraindicated for a particular user 190 (e.g. consumable composition identification data 126-3 associated with a detected consumable composition may include one or more look-up table fields associated with one or more contraindicated consumable compositions). Alternately, the identities of at least one of the first consumable composition and second consumable composition may be transmitted to an ancillary system or device for analysis. For example, the communications module 130 may transmit detected consumable composition identity data to a monitoring entity 180 (e.g. a system associated with a physician) or a controllable device 185 (e.g. a wrist alarm, smart medicine cabinet, paramedic robot, and the like) to perform an interaction calculation.

FIG. 12 shows that Operation 1202, detecting a contraindication between the first dose of a consumable composition and the second dose of a consumable composition, may in some instances further include Operation 1204. Operation 1204 illustrates detecting a chemical interaction between the first dose of a consumable composition and the second dose of a consumable composition (e.g. detecting a deactivation of the functionality of a pharmaceutical consumable composition by a vitamin supplement). For example, as shown in FIG. 1, a chemical interaction between the first consumable composition and the second consumable composition may be detected by sensor module 150 (e.g. a spectrophotometer sensor) by detecting one or more chemical byproducts of a chemical reaction between the first consumable composition and the second consumable composition The chemical interaction between the first consumable composition and the second consumable composition as detected in Operation 1204 may be used in detecting a calculated contraindication between the first consumable composition and the second consumable composition (Operation 1202). For instance, the presence of one or more chemical byproducts may be indicative of a contraindicated interaction between the first consumable composition and the second consumable composition.

FIG. 12 shows that Operation 1204, detecting a chemical interaction between the first dose of a consumable composition and the second dose of a consumable composition, may in some instances include Operation 1206. Operation 1206 illustrates detecting a calculated chemical interaction between the first dose of a consumable composition and the second dose of a consumable composition (e.g. detecting a potential deactivation of the functionality of a pharmaceutical consumable composition by a vitamin supplement based on data maintained in memory 126). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which may react chemically with the first dose of consumable composition (e.g. consumable composition identification data 126-3 associated with a detected consumable composition may include one or more look-up table fields associated with one or more contraindicated consumable compositions which react with the first consumable composition to produce undesired byproducts). The calculated chemical interaction between the first consumable composition and the second consumable composition as detected in Operation 1206 may be used in detecting a contraindication between the first consumable composition and the second consumable composition (Operation 1204). For instance, the consumable composition identification data 126-3 may include contraindication data representing consumable composition combinations which may be chemically incompatible and therefore, should not be administered within a given time period.

FIG. 12 shows that Operation 1202, detecting a contraindication between the first dose of a consumable composition and the second dose of a consumable composition, may in some instances further include Operation 1208. Operation 1208 illustrates detecting a calculated conflict between a physiological response associated with an ingestion of the first dose of a consumable composition and a physiological response associated with an ingestion of the second dose of a consumable composition (e.g. detecting proximate dispensations of an anti-coagulant, such as warfarin, and a blood pressure medication, such as a beta-blocker). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which, in combination with the first dose of consumable composition, may be associated with a an undesirable physiological response in a user 190 (e.g. consumable composition identification data 126-3 associated with a detected consumable composition may include one or more look-up table fields associated with one or more contraindicated consumable compositions which result in one or more incompatible physiological responses in user 190). The calculated physiological conflicts between the first consumable composition and the second consumable composition as detected in Operation 1208 may be used in detecting a contraindication between the first consumable composition and the second consumable composition (Operation 1202). For instance, the consumable composition identification data 126-3 may include contraindication data representing consumable composition combinations which may result in incompatible physiological responses in a user 190, and therefore, should not be administered within a given time period.

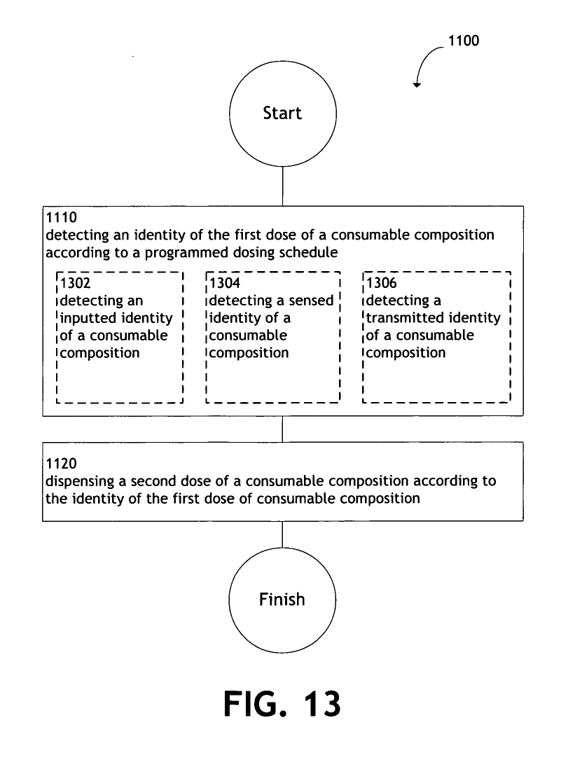

FIG. 13 illustrates an example embodiment where the operation 1110 of example operational flow 1100 of FIG. 11 may include at least one additional operation. Additional operations may include an operation 1302, an operation 1304, and/or an operation 1306.

FIG. 13 shows that Operation 1110, detecting an identity of a first dose of a consumable composition dispensed according to a programmed dosing schedule, may in some instances further Operation 1302. Operation 1302 illustrates detecting an inputted identity of a consumable composition (e.g. receipt of a user input identifying a consumable composition whose functionality may be affected by a second dose of a consumable composition). For example, as shown in FIG. 1, a user 190 may input an identity of a consumable composition via an input module 146 (e.g. a touch screen) of a user interface 140.

FIG. 13 shows that Operation 1110, detecting an identity of a first dose of a consumable composition dispensed according to a programmed dosing schedule, may in some instances include Operation 1304. Operation 1304 illustrates detecting a sensed identity of a consumable composition (e.g. receipt of identification data from a label identifying a consumable composition whose functionality may be affected by a second dose of a consumable composition). For example, as shown in FIG. 1, the input module 146 of user interface 140 may include a bar code reader for reading a barcode from a label on a container for a consumable composition.

FIG. 13 shows that Operation 1110, detecting an identity of a first dose of a consumable composition dispensed according to a programmed dosing schedule, may in some instances further include Operation 1306. Operation 1306 illustrates detecting a transmitted identity of a consumable composition (e.g. receipt of identification data from a physician identifying a consumable composition whose functionality may be affected by a second dose of a consumable composition). For example, as shown in FIG. 1, the communications module 130, may receive consumable composition identification data from a monitoring system 180 (e.g. a system associated with a physician, a system associated with a consumable composition supply entity, or the like).

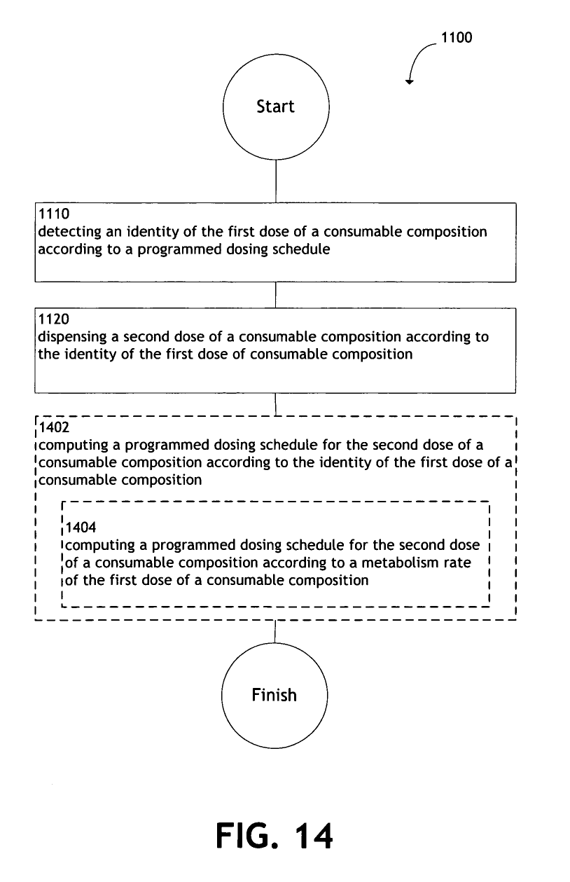

FIG. 14 illustrates an example embodiment where example operational flow 1100 of FIG. 11 may include at least one additional operation. Additional operations may include an operation 1402, and/or an operation 1404.

FIG. 14 shows that Operation flow 1100, may in some instances further include Operation 1402. Operation 1402 illustrates computing a programmed dosing schedule for the second dose of a consumable composition according to the identity of the first dose of a consumable composition (e.g. a dose of an anti-coagulant may be scheduled for dispensation immediately following a dose of a narcotic but must be separated by a given time period from a dose of aspirin). For example, as shown in FIG. 1, sensing logic 124 may cause sensor module 150 to detect an identity (e.g. a chemical composition) of a first dose of a consumable composition which may be compared to consumable composition data 126-3. The consumable composition identification data 126-3 may include consumable composition interaction data regarding chemical and/or physiological interactions between various consumable compositions. The interaction data may include time values which must separate administration of doses of consumable composition pairs so as to avoid chemical and/or physiological interactions between consumable compositions. Upon detection of the identity of the first dose of a consumable composition, detection logic 121 may calculate a dosing schedule (e.g. 4 hours following administration of the first dose of a consumable composition) for the second dose of a consumable composition based on the interaction data. The dosing schedule for the second dose of a consumable composition may be stored as a dispensing program 126-2 in memory 126.

FIG. 14 shows that Operation 1402, computing a programmed dosing schedule for the second dose of a consumable composition according to the identity of the first dose of a consumable composition, may in some instances further include Operation 1404. Operation 1404 illustrates computing a programmed dosing schedule for the second dose of a consumable composition according to a metabolism rate of the first dose of a consumable composition (e.g. a blood thinner may take 24 hours to fully metabolize in order to allow for a contraindicated dose of aspirin). For example, as shown in FIG. 1, composition identification data 126-3 maintained in memory 126 may include consumable composition interaction data regarding chemical and/or physiological interactions between various consumable compositions. The identification data may include metabolism rates for the consumable compositions. Upon detection of the identity of the first dose of a consumable composition, dispensing logic 125 may calculate a programmed dosing schedule for the second dose of a consumable composition based on the metabolism rate data (e.g. consumable composition A is metabolized at a rate of 50 mg/hour so a dose of contraindicated consumable composition B may be administered 2 hours following a 100 mg dose of consumable composition A). The identity and associated metabolism rate of the first consumable composition as detected in Operation 1404 may be used in computing a programmed dosing schedule for the second consumable composition (Operation 1402). For instance, a dosing schedule which avoids dispensing the second dose of a consumable composition until the first dose of consumable composition has been calculated as metabolized may be stored as a dispensing program 126-2 in memory 126.

Although a user 190 is shown/described herein as a single illustrated figure, those skilled in the art will appreciate that a user 190 may be representative of a human user, a robotic user (e.g., computational entity), and/or substantially any combination thereof (e.g., a user may be assisted by one or more robotic agents). In addition, a user 190, as set forth herein, although shown as a single entity may in fact be composed of two or more entities. Those skilled in the art will appreciate that, in general, the same may be said of “sender” and/or other entity-oriented terms as such terms are used herein.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into high-level descriptor languages (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include all possible multiple dependencies.

1. A method for administering a consumable composition, the method comprising:
detecting an administration of a first dose of a consumable composition according to a programmed dosing schedule; and
dispensing a second dose of a consumable composition according to a time interval since the administration of a first dose of the first consumable composition.

2-24. (canceled)

25. A system for administering a consumable composition, the system comprising:
means for detecting an administration of a first dose of a consumable composition according to a programmed dosing schedule; and
means for dispensing a second dose of a consumable composition according to a time interval since the administration of a first dose of the first consumable composition.

26. The system of claim 25, wherein the means for detecting an administration of a first dose of a consumable composition according to a programmed dosing schedule further comprises:
means for detecting a dispensation of a first dose of a consumable composition according to a programmed dosing schedule.

27. The system of claim 26, wherein the means for detecting a dispensation of a first dose of a consumable composition according to a programmed dosing schedule further comprises:
means for detecting an amount of consumable composition dispensed.

28. The system of claim 27, wherein the means for detecting an amount of consumable composition dispensed further comprises:
means for measuring a flow rate of a dispensed consumable composition from a consumable composition dispenser over a time interval.

29. The system of claim 27, wherein the means for detecting an amount of consumable composition dispensed further comprises:
means for calculating a flow rate of a dispensed consumable composition from a consumable composition dispenser over a time interval.

30. The system of claim 27, wherein the means for detecting an amount of consumable composition dispensed further comprises:
means for measuring a volume of a consumable composition contained in a consumable composition storage.

31. The system of claim 27, wherein the means for detecting an amount of consumable composition dispensed further comprises:
means for measuring a mass of a consumable composition contained in a consumable composition storage.

32. The system of claim 27, wherein the means for detecting an amount of consumable composition dispensed further comprises:
means for measuring a capacitance of a consumable composition contained in a consumable composition storage.

33. The system of claim 27, wherein the means for detecting an amount of consumable composition dispensed further comprises:
means for detecting a number of definable consumable composition doses dispensed.

34. The system of claim 33, wherein the means for detecting a number of definable consumable composition doses dispensed further comprises:
means for detecting a radio frequency signal associated with a radio frequency identification tag.

35. The system of claim 25, wherein the means for detecting an administration of a first dose of a consumable composition according to a programmed dosing schedule further comprises:
means for detecting an ingestion of a first dose of a consumable composition.

36. The system of claim 35, wherein the means for means for detecting an ingestion of a first dose of a consumable composition further comprises:
means for detecting at least one calculated ingestion of the first dose of a consumable composition.

37. The system of claim 36, wherein the means for detecting at least one calculated ingestion of the first dose of a consumable composition further comprises:
means for detecting a presence of a bodily fluid.

38. The system of claim 36, wherein the means for detecting at least one calculated ingestion of the first dose of a consumable composition further comprises:
means for detecting a movement of a beverage container containing the consumable composition.

39. The system of claim 36, wherein the means for detecting at least one calculated ingestion of the first dose of a consumable composition further comprises:
means for detecting a pressure applied to a beverage container containing the consumable composition.

40. The system of claim 36, wherein the means for detecting at least one calculated ingestion of the first dose of a consumable composition further comprises:
means for detecting a volume of fluid in a beverage container containing the consumable composition.

41. The system of claim 36, wherein the means for detecting at least one calculated ingestion of the first dose of a consumable composition further comprises:
means for detecting a mass of fluid in a beverage container containing the consumable composition.

42. The system of claim 36, wherein the means for detecting at least one calculated ingestion of the first dose of a consumable composition further comprises:
means for detecting a capacitance of fluid in a beverage container containing the consumable composition.

43. The system of claim 36, wherein the means for detecting at least one calculated ingestion of the first dose of a consumable composition further comprises:
means for detecting an outflow rate of the consumable composition from a beverage container containing the consumable composition.

44. The system of claim 43, wherein the means for detecting an outflow rate of the consumable composition from a beverage container containing the consumable composition further comprises:
means for detecting a rate of change of a volume of a fluid in a beverage container containing the consumable composition.

45. The system of claim 43, wherein the means for detecting an outflow rate of the consumable composition from a beverage container containing the consumable composition further comprises:
means for detecting a rate of change of a mass of a fluid in a beverage container containing the consumable composition.

46. The system of claim 43, wherein the means for detecting an outflow rate of the consumable composition from a beverage container containing the consumable composition further comprises:
means for detecting a rate of change of a capacitance of a fluid in a beverage container containing the consumable composition.

47. The system of claim 36, wherein the means for detecting at least one calculated ingestion of the first dose of a consumable composition further comprises:
means for detecting a degree of inclination of a beverage container containing the consumable composition.

48. The system of claim 36, wherein the means for detecting at least one calculated ingestion of the first dose of a consumable composition further comprises:
means for detecting non-ingestion of a consumable composition.

49. A method for administering a consumable composition, the method comprising:
detecting an identity of a first dose of a consumable composition dispensed according to a programmed dosing schedule; and
dispensing a second dose of a consumable composition according to the identity of the first dose of a consumable composition.

50-58. (canceled)

59. A system for administering a consumable composition, the system comprising:
means for detecting an identity of a first dose of a consumable composition dispensed according to a programmed dosing schedule; and
means for dispensing a second dose of a consumable composition according to the identity of the first dose of a consumable composition.

60. The system of claim 59, wherein the means for detecting an identity of a first dose of a consumable composition dispensed according to a programmed dosing schedule further comprises:
means for detecting a contraindication between the first dose of a consumable composition and the second dose of a consumable composition.

61. The system of claim 60, wherein the means for detecting a contraindication between the first dose of a consumable composition and the second dose of a consumable composition further comprises:
means for detecting a chemical interaction between the first dose of a consumable composition and the second dose of a consumable composition.

62. The system of claim 61, wherein the means for detecting a chemical interaction between the first dose of a consumable composition and the second dose of a consumable composition further comprises:
means for detecting a calculated chemical interaction between the first dose of a consumable composition and the second dose of a consumable composition.

63. The system of claim 60, wherein the means for detecting a contraindication between the first dose of a consumable composition and the second dose of a consumable composition further comprises:
means for detecting a calculated conflict between a physiological response associated with an ingestion of the first dose of a consumable composition and a physiological response associated with an ingestion of the second dose of a consumable composition.

64. The system of claim 59, wherein the means for detecting an identity of a first dose of a consumable composition dispensed according to a programmed dosing schedule further comprises:
means for detecting an inputted identity of a consumable composition.

65. The system of claim 59, wherein the means for detecting an identity of a first dose of a consumable composition dispensed according to a programmed dosing schedule further comprises:
means for detecting a sensed identity of a consumable composition.

66. The system of claim 59, wherein the means for detecting an identity of a first dose of a consumable composition dispensed according to a programmed dosing schedule further comprises:
means for detecting a transmitted identity of a consumable composition.

67. The system of claim 59, further comprising:
means for computing a programmed dosing schedule for the second dose of a consumable composition according to the identity of the first dose of a consumable composition.

68. The system of claim 67, wherein the means for computing a programmed dosing schedule for the second dose of a consumable composition according to the identity of the first dose of a consumable composition further comprises:
means for computing a programmed dosing schedule for the second dose of a consumable composition according to a metabolism rate of the first dose of a consumable composition.
